(19) United States
(12) Patent Application Publication
(10) Pub. No.: US 2026/0229255 A1
(43) Pub. Date: Aug. 6, 2026

(54) Machine-Learned Audio Editing Model

(71) Applicant: Google LLC, Mountain View, CA (US)

(72) Inventors: Ron Weiss, New York, NY (US); Eduardo David Fonseca Montero, New York City, NY (US); Dan Ellis, New York, NY (US); Scott Thomas Wisdom, Cambridge, MA (US); Aren Jansen, Mountain View, CA (US); Richard Channing Moore, III, Brooklyn, NY (US); Efthymios Tzinis, Cambridge, MA (US); Pascal Tom Getreuer, San Francisco, CA (US); Hakan Erdogan, Lexington, MA (US); John Randall Hershey, Cambridge, MA (US); Kevin William Wilson, Cambridge, MA (US); Manoj Plakal, New York, NY (US); Vivek Kumar, Foster City, CA (US)

(21) Appl. No.: 19/531,354

(22) Filed: Feb. 5, 2026

Related U.S. Application Data
(60) Provisional application No. 63/754,171, filed on Feb. 5, 2025.
(60) Provisional application No. 63/808,402, filed on May 19, 2025.

(51) Int. Cl. G11B 27/031

(52) U.S. Cl. CPC G11B 27/031

(57) ABSTRACT

Provided are systems and methods that leverage machine learning to perform audio editing with improved precision and flexibility. Some example systems utilize a vector-based audio editing representation to condition and control a machine-learned audio editing model. This approach allows for detailed and precise control over audio edits by encoding the edits numerically and processing the encoding with a trained model. The system can handle a variety of edits, including audio generation, removal, transformation, time-shifting, and/or enhancement, thereby providing a comprehensive tool for audio manipulation.

### RELATED APPLICATIONS

This application claims priority to and the benefit of U.S. Provisional Patent Application No. 63/754,171, filed Feb. 5, 2025 and United States Provisional Patent Application No. 63/808,402, filed May 19, 2025. United States Provisional Patent Application No. 63/754,171 and U.S. Provisional Patent Application No. 63/808,402 are hereby incorporated by reference in their entirety.

### FIELD

The present disclosure relates generally to machine learning processes and machine-learned devices and systems. More particularly, the present disclosure relates to systems and methods that leverage machine learning to perform audio editing with improved precision and flexibility.

### BACKGROUND

Traditional tools for performing audio editing typically require manual intervention for tasks such as inserting new sounds, removing unwanted noise, transforming audio properties, or shifting audio events in time. This manual process can be time-consuming, prone to errors, and require a high level of expertise to ensure precision. Furthermore, existing systems often lack the capability to handle complex audio editing tasks, such as synchronizing audio with visual elements and/or dynamically adjusting specific audio elements within a dense mix without affecting the overall audio integrity.

Moreover, existing audio editing systems often do not support real-time feedback or iterative improvements based on advanced modeling techniques, limiting the ability of editors to experiment with different edits efficiently. This lack of flexibility and support for advanced audio manipulation can increase production times, resulting in redundant edits which unnecessarily consume computational resources.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for audio editing. The computer-implemented method includes obtaining, by a computing system may include one or more computing devices, input data descriptive of an input audio signal; generating, by the computing system, a vector-based audio editing representation that numerically describes one or more edits to the input audio signal; processing, by the computing system, the input data and the vector-based audio editing representation with a machine-learned audio editing model to generate, as an output of the machine-learned audio editing model, output data descriptive of an output audio signal, where the output audio signal corresponds to the one or more edits to the input audio signal; and providing, by the computing system, the output data as an output. Other embodiments of this aspect include corresponding computer systems, apparatus, and computer programs recorded on one or more computer storage devices, each configured to perform the actions of the methods.

Implementations may include one or more of the following features. The computer-implemented method where the input data may include an input audio spectrogram or where the output data may include an output audio spectrogram. Generating, by the computing system, the vector-based audio editing representation may include: receiving, by the computing system, editing control data generated based on one or more user interactions with an editing user interface may include an interactive event roll visualization, where the interactive event roll visualization depicts a plurality of values respectively for a plurality of different sound classes over time; and generating, by the computing system, the vector-based audio editing representation based at least in part on the editing control data. The computer-implemented method may include, prior to receiving the editing control data: analyzing, by the computing system, the input audio signal with a sound classifier model to generate an initial set of values for the interactive event roll visualization; and providing, by the computing system, the interactive event roll visualization for display in the editing user interface with the initial set of values. The one or more user interactions with the editing user interface may include user interactions that modify one or more of the plurality of values of the interactive event roll visualization. Generating the vector-based audio editing representation based at least in part on the editing control data may include: determining, by the computing system, a difference event roll that indicates a difference between an initial version of the interactive event roll visualization and a final version of the interactive event roll visualization following the user interactions that modify the one or more of the plurality of values of the interactive event roll visualization; and generating, by the computing system, the vector-based audio editing representation based at least in part on the difference event roll. The one or more user interactions may include: one or more free-form textual inputs that textually describe the one or more edits to the input audio signal; and one or more activity rolls that respectively indicate temporal boundaries of the one or more edits to the input audio signal. Generating, by the computing system, the vector-based audio editing representation based at least in part on the editing control data may include: generating, by the computing system, a textual embedding for each free-form textual input; and generating, by the computing system, the vector-based audio editing representation that numerically indicates the textual embedding and the temporal boundaries for each free-form textual input. The one or more edits to the input audio signal may include an audio generation edit, an audio removal edit, an audio transformation edit, an audio time-shifting edit, and an audio enhancement edit. The machine-learned audio editing model may include a sequence processing model. Processing, by the computing system, the input data and the vector-based audio editing representation with the machine-learned audio editing model may include processing the input data with the machine-learned audio editing model while performing cross-attention on the vector-based audio editing representation. The input data may include an input audio waveform or where the output data may include an output audio waveform. The input data may include an input sequence of audio tokens or where the output data may include an output sequence of audio tokens. Implementations of the described techniques may include hardware, a method or process, or computer software on a computer-accessible medium.

One general aspect includes a computing system configured to train a machine-learned audio editing model. The computing system also includes one or more processors; and one or more non-transitory computer-readable media that collectively store instructions for performing operations, the operations may include: obtaining, by a computing system may include one or more computing devices, input data descriptive of an input audio signal, a vector-based audio editing representation that numerically describes one or more edits to the input audio signal, and target data descriptive of a target audio signal, where the target audio signal demonstrates the one or more edits to the input audio signal; processing, by the computing system, the input data and the vector-based audio editing representation with a machine-learned audio editing model to generate, as an output of the machine-learned audio editing model, output data descriptive of an output audio signal; evaluating, by the computing system, one or more loss functions that compare the output data to the target data; and modifying, by the computing system, one or more values of one or more parameters of the machine-learned audio editing model based on the one or more loss functions. Other embodiments of this aspect include corresponding computer systems, apparatus, and computer programs recorded on one or more computer storage devices, each configured to perform the actions of the methods.

Implementations may include one or more of the following features. The computing system where the input audio signal may include background audio content; and where obtaining, by the computing system, the input data and the target data may include inserting foreground audio into the input audio signal to generate the target audio signal. The target audio signal may include background audio content; and where obtaining, by the computing system, the input data and the target data may include inserting foreground audio into the target audio signal to generate the input audio signal. Obtaining, by the computing system, the input data and the target data may include inserting first foreground audio into a background signal to generate the input audio signal and inserting second, different foreground audio into the background signal to generate the target audio signal. Obtaining, by the computing system, the input data and the target data may include inserting foreground audio into a background signal at a first time to generate the input audio signal and inserting the foreground audio into the background signal at a second, different time to generate the target audio signal. Obtaining, by the computing system, the input data and the target data may include increasing a volume of at least a portion of the input audio signal to generate the target audio signal. Implementations of the described techniques may include hardware, a method or process, or computer software on a computer-accessible medium.

One general aspect includes one or more non-transitory computer-readable media that collectively store a machine-learned audio editing model configured to process input data descriptive of an input audio signal and a vector-based audio editing representation that numerically describes one or more edits to the input audio signal to generate Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1A illustrates a flow diagram of an audio editing system that can utilize a machine-learned model for processing audio data according to example implementations of aspects of the present disclosure;

FIG. 1B illustrates example event rolls according to example implementations of aspects of the present disclosure;

FIG. 2 provides a schematic diagram illustrating the training process of a machine-learned audio editing model according to example implementations of aspects of the present disclosure;

FIG. 3 is a flow chart diagram illustrating an example method for training a machine-learned model according to example implementations of aspects of the present disclosure;

FIG. 4 is a block diagram of an example processing flow for using machine-learned model(s) to process input(s) to generate output(s) according to example implementations of aspects of the present disclosure;

FIG. 5 is a block diagram of an example sequence processing model according to example implementations of aspects of the present disclosure;

FIG. 6 is a block diagram of an example technique for populating an example input sequence for processing by a sequence processing model according to example implementations of aspects of the present disclosure;

FIG. 7 is a block diagram of an example model development platform according to example implementations of aspects of the present disclosure;

FIG. 8 is a block diagram of an example training workflow for training a machine-learned model according to example implementations of aspects of the present disclosure;

FIG. 9 is a block diagram of an inference system for operating one or more machine-learned model(s) to perform inference according to example implementations of aspects of the present disclosure;

FIG. 10 is a block diagram of an example networked computing system according to example implementations of aspects of the present disclosure;

FIG. 11 is a block diagram of an example computing device according to example implementations of aspects of the present disclosure; and

FIG. 12 is a block diagram of an example computing device according to example implementations of aspects of the present disclosure.

### DETAILED DESCRIPTION

Example aspects of the present disclosure are directed to systems and methods that leverage machine learning to perform audio editing with improved precision and flexibility. Traditional audio editing tools often lack the ability to specify detailed and/or semantically-driven edits at precise time intervals, instead relying heavily on manual adjustments that can be time-consuming and imprecise. As another example, certain existing technologies provide text-based editing commands but do not allow for fine-grained temporal control, which can lead to inaccuracies in the desired audio output.

In contrast, the present disclosure provides solutions which utilize a vector-based audio editing representation to condition and control a machine-learned audio editing model. This approach allows for detailed and precise control over audio edits by encoding the edits numerically and processing the encoding with a trained model. Specifically, the vector-based audio editing representation can encode information regarding the precise temporal locations of specific edit(s) within the audio signal. This is in contrast to prior systems which do not encode fine-grained temporal information into editing instructions. The system can handle a variety of edits, including audio generation, removal, transformation, time-shifting, and/or enhancement, thereby providing a comprehensive tool for audio manipulation.

One specific aspect of the proposed approach is the use of an interactive event roll visualization in an editing interface. This feature enables users to interact with a graphical representation of audio events, making it easier to specify and visualize changes. Users can, for instance, insert new audio events, delete unwanted ones, and/or modify the properties of existing events directly through the interface. The system then translates these interactions into a vector-based representation that the audio editing model processes.

Furthermore, in some implementations, the audio editing system supports the integration of free-form textual inputs (e.g., as a form of interaction with the event roll visualization). These textual inputs can be transformed into textual embeddings which can be inserted into or otherwise included in the vector-based audio editing representation, thereby providing rich semantic information in a format that is interpretable by the audio editing model. This feature allows users to describe desired edits in natural language, increasing flexibility and user-friendliness.

More particularly, one example aspect is directed to a computing system that can perform audio editing. In particular, the system can obtain input data that describes an input audio signal. This data can be in various forms such as a raw audio signal, an audio spectrogram, or a sequence of audio tokens. The system can also be capable of transforming audio data into or between these forms. The flexibility to use different types of audio data allows the system to be adaptable to a wide range of audio editing applications.

According to another aspect of the present disclosure, the computing system can generate a vector-based audio editing representation that numerically describes one or more edits (e.g., user-specified edits) to the input audio signal. In some implementations, this representation can be structured as a matrix and/or a set of vectors where each vector corresponds to specific edits, such as additions or deletions, and encodes respective details about temporal information and sound class, type, or semantics. For instance, the system can encode an instruction to add a dog bark sound at a particular time interval as a positive value in the vector, while a command to remove background audio content during a different interval can be represented as a negative value. This numerical method allows for a precise and efficient way to convey complex editing instructions to the machine-learned audio editing model.

In some implementations, the computing system can generate the vector-based audio editing representation by first receiving editing control data. This data can be generated based on user interactions with an editing user interface. Based on user interactions with the editing user interface, the system can generate the vector-based audio editing representation, which numerically encodes these modifications. This process translates user adjustments into a format that the audio editing model can process.

In some implementations, the editing user interface can include an interactive event roll visualization. This visualization can display a range of values (e.g., represented visually using colors, shading, etc.) for various sound classes or types over time. The interactive event roll visualization can enable users to interactively manipulate audio properties directly. For example, a user can adjust the volume of a specific sound class or extend the duration of certain audio events by adjusting the values in the visualization.

In some implementations, prior to receiving the editing control data (e.g., as part of providing the editing user interface), the computing system can analyze the input audio signal using a sound classifier model to generate an initial set of values for the interactive event roll visualization. This initial analysis can include identifying different sound classes present in the audio signal, such as speech, music, or environmental noises, and determining their temporal occurrences within the audio. These values are then used to populate the interactive event roll visualization, which is subsequently provided for display in the editing user interface. For example, the visualization can show segments where speech is detected or highlight areas with background music. This approach allows users to visually comprehend the composition of the audio track before making any edits.

In addition to improving visual comprehension, the interactive interface enables the user to manipulate whole events (e.g., “the dog bark”). Specifically, the classifier provides precise timings for events and the user can interact with the initial timings in whole or in part. In some implementations, these representations of event timing are forwarded to the audio editing model, and therefore the ability of the audio editing model to understand and interact with (e.g., edit) audio content that corresponds to specific events can be improved. Thus, the proposed techniques provide both intuitive interfaces for human users and also create structured information which can improve model performance.

In some implementations, user interactions with the editing user interface can modify one or more of the plurality of values of the interactive event roll visualization. These user interactions may include actions such as adjusting the duration of a sound event, changing the volume, or even adding new sound events into the audio track. For example, a user can extend the duration of a laughter segment in a podcast to enhance its effect or decrease the volume of background traffic noise in a video recording. These modifications can be directly reflected in the interactive event roll visualization, providing immediate visual feedback to the user. This feature allows users to make precise temporal and sound-type-specific adjustments to the audio content.

In some implementations, generating the vector-based audio editing representation can include determining a difference event roll by the computing system. This difference event roll can highlight or otherwise specify the changes between the initial and final versions of the interactive event roll visualization, thus reflecting the modifications made by user interactions. For example, if a user adjusts the length of a sound event or modifies its volume, these changes are captured in the difference event roll. Subsequently, the computing system can generate the vector-based audio editing representation based on this difference event roll. This representation then serves as a precise numerical description of all user-specified edits. Thus, in some implementations, the difference event roll can indicate edits with respect to a number of different sound classes (e.g., which may be a fixed set of classes) over time. As one example for illustration, in an example difference roll the Y-axis may correspond to different sound classes (e.g., 80 classes). For example, each row on the Y-axis may correspond to one of the different sound classes. The X-axis can correspond to time. Thus, the values within each row can indicate what to edit (e.g., based on amplitude of the values and their class/row position) and when the edits should be performed (e.g., based on the position of the values along the X-axis representative of time).

According to another aspect of the present disclosure, in some implementations, the user interactions with the audio editing interface can include one or more free-form textual inputs along with one or more activity rolls. The free-form textual inputs allow users to describe the desired edits to the input audio signal in their own words, such as specifying to “increase the clarity of the vocals” or “add echo to the background footsteps.” Concurrently, the activity rolls provide a structured method to indicate the temporal boundaries for each of these edits, specifying exactly when the changes should start and stop within the audio timeline. For example, a user can input text to “diminish the sound of traffic” and use an activity roll to apply this edit from the second to the fifth minute of the recording.

More particularly, in some implementations, the activity roll may be structured similar to the difference event roll in the sense that, in some examples, the Y-axis corresponds to different sound edits; while the X-axis corresponds to time. However, an activity roll can indicate time activations of any type of edit (e.g., the Y-axis does not correspond to a fixed set of classes, but to a variable set of edit instructions unknown to the roll). For example, each row in the activity roll can be associated with a text embedding which may encode a more nuanced semantic edit, e.g., as compared to a fixed sound class. Thus, the activity roll generally encodes only when to edit, i.e., when a given instruction is active; while the textual embedding(s) generated from the free-form textual input(s) respectively indicate the semantic content of the requested edit(s).

In some implementations, the free-form textual input and/or the activity roll can be provided as an input to and/or derived via user interaction with the interactive event roll visualization. For example, a user may create a new row within the visualization and then specify one or more temporal boundaries within the row (e.g., by highlighting some, but not all of the cells in the row), thereby creating the activity roll. The user can then input the free-form text which can be associated with the activity roll.

In some implementations in which free-form textual inputs are provided, the computing system can generate the vector-based audio editing representation by first creating a textual embedding for each free-form textual input received from the user. These textual embeddings are numerical representations that capture the semantic essence of the user's textual instructions, such as “change the laughter from sad to hysterical.” Following this, the system can generate the vector-based audio editing representation that numerically integrates these textual embeddings with the specified temporal boundaries from the activity rolls. For example, if a user inputs a command to “increase vocal clarity from minute 1 to minute 3,” the system would generate an embedding for this instruction and pair it with the corresponding temporal data in the vector-based representation.

After generation of the vector-based audio editing representation, the computing system can then process the input data and the vector-based audio editing representation with a machine-learned audio editing model to generate output data descriptive of an output audio signal. This output audio signal corresponds to the one or more edits specified in the vector-based audio editing representation. For example, if the editing representation indicates an enhancement of laughter within a certain time frame, the machine-learned model can modify the input audio signal to amplify laughter sounds during that specific interval. The audio editing model can be trained to recognize various sound classes, types, or other semantic representations and to apply the desired edits, such as adding, removing, or transforming sounds according to the instructions encoded in the vector-based representation. The audio editing model therefore performs the automated generation of an output audio signal that accurately reflects all specified edits, facilitating efficient and precise audio editing tasks.

In some implementations, the computing system can provide the output data as an output. This output data, which is descriptive of the output audio signal, can be output in various forms suitable for different applications, such as a raw audio waveform, a spectrogram, and/or as audio tokens. For example, the output data can be delivered as an audio file in formats such as WAV or MP3, or it could be streamed directly to audio playback devices. As another example, the output data can be used in further audio processing stages or integrated into multimedia projects.

In some implementations, the machine-learned audio editing model utilized in the system can be or include a sequence processing model (e.g., a Transformer-based model), which is adept at handling data where the order of elements is significant, such as audio signals. As one example, the machine-learned audio editing model could be similar to or include a RQ-Transformer as described in Lee et al., Autoregressive Image Generation using Residual Quantization, arXiv:2203.01941 [cs.CV]. Additionally, other types of models, such as diffusion models, can also be employed depending on the specific requirements of the audio editing tasks.

In some implementations, the processing of the input data and the vector-based audio editing representation with the machine-learned audio editing model can include performing cross-attention on the vector-based audio editing representation. This allows the model to focus on specific parts of the input data that are relevant to the edits described in the vector-based representation. For example, if the vector-based representation indicates an enhancement of a particular sound at a certain time, the model, through cross-attention, can prioritize this segment of the audio during processing. This focused approach helps in effectively applying the desired edits.

The proposed system can perform various types of edits to the input audio signal. As one example, an audio generation edit can include adding new sound elements, such as inserting a laughter track at a specific moment in a podcast. As another example, an audio removal edit can include deleting unwanted noise or silencing parts of the track, enhancing the overall clarity of the audio. As another example, an audio transformation edit can alter the characteristics of the sound, for instance, changing the pitch or tempo of a sound (e.g., changing the bark of a dog to the meow of a cat). As another example, an audio time-shifting edit allows for the adjustment of the timing of audio events, such as delaying the start of a sound effect to better sync with video content. As yet another example, an audio enhancement edit can improve the quality of the audio, such as increasing the volume of sound to make it more prominent. These edits can be applied individually or in combination.

In some implementations, an example training approach for the machine-learned audio editing model can include the following steps. Initially, the computing system obtains input data that describes an input audio signal, along with a vector-based audio editing representation that numerically details one or more edits to be applied to this signal, and target data that illustrates the desired outcome of these edits. The model then processes the input data and the editing representation to generate output data, which is an audio signal that reflects the intended edits. Following this, the computing system evaluates the performance of the model using one or more loss functions that compare the output data to the target data. For example, these loss functions can measure how closely the output audio matches the target audio in terms of sound quality and/or accuracy of the edits applied. Based on the results of this evaluation, the system can modify the parameters of the audio editing model to minimize discrepancies and improve future performance. This iterative process of evaluation and modification helps in refining the model's ability to execute complex audio edits with high precision.

In some implementations, the computing system can create a training example by obtaining an input audio signal that primarily consists of background audio content and inserting foreground audio to create a target audio signal. This process can include obtaining input data that describes the background audio content, such as ambient sounds in a café or street noise or purely specular noise, and then integrating specific foreground sounds, such as knocking on a door, to generate the desired composite audio. This approach represents the creation of a training example that can be used to learn to perform additional edits. Specifically, the input audio signal is the input, the edit instructions can include instructions to add the foreground audio, and the target audio signal can be the signal that has the foreground audio included.

In some implementations, the computing system can generate a training example that demonstrates a sound removal edit. For example, the computing system can create an input audio signal by inserting foreground audio into a target audio signal that predominantly consists of background audio content. This process can include obtaining target data that describes the ambient or environmental noise, and then enhancing this base layer by adding distinct foreground sounds, such as specific sound effects. Thus, in this example, the signal with the foreground audio added is the training input, the edit instructions include instructions to remove the foreground audio, and the original background only audio is the training target.

In some implementations, the computing system can create a training example that demonstrates a transform edit. For example, the computing system can generate both the input and target training audio signals by incorporating different foreground audio elements into a shared background signal. This process can include inserting a first type of foreground audio, such as dialogue or specific sound effects, into the background signal to generate the input audio signal. Subsequently, a second, different type of foreground audio is inserted into the same background signal to generate the target audio signal. For example, the system can add street noise to a cityscape background to create the input audio, and then add sirens and crowd noises to the same cityscape background for the target audio. This approach allows the audio editing model to learn how to transform or enhance specific aspects of the audio by comparing these two versions.

In some implementations, the computing system can generate a training example that demonstrates a temporal shift edit. For example, the computing system can generate both input and target audio signals by inserting the same foreground audio into a consistent background signal, but at different times. This can include adding the foreground audio to the background signal at a first specified time to create the input training audio signal, and then inserting the same foreground audio into the background signal at a second, different specified time to generate the target training audio signal. This method allows the audio editing model to learn time-shifting edits effectively by providing it with examples where the only variable is the timing of the same sound within the same context.

In some implementations, the computing system can generate a training example that demonstrates an enhance edit. For example, the computing system can generate the target training audio signal by increasing the volume of at least a portion of the input audio signal. This process can include selectively amplifying specific segments of the audio track, such as enhancing the loudness of dialogue in a movie scene to make it more audible over background audio content. For example, if the input audio can include a conversation in a busy café, the system can increase the volume of the voices while maintaining the background ambiance at its original level to produce the target audio.

The systems and methods of the present disclosure provide a number of technical effects and benefits. As one example, the systems and methods of the present disclosure provide a significant advancement in the field of audio editing by enabling precise control (e.g., precise temporal control) over audio modifications through a vector-based audio editing representation. This representation numerically encodes edits, such as deletions, insertions, and transformations of audio signals, which can be processed by a machine-learned model. The numerical encoding of audio edits allows for a high degree of precision in specifying the temporal and qualitative aspects of each edit. This is a clear technical improvement over traditional methods, which often rely on less precise, manual adjustments or do not allow such fine-grained control at all. The ability to specify and automate edits with such precision directly addresses the technical problem of reducing errors and increasing efficiency in audio editing processes.

As another example technical effect, the use of a machine-learned audio editing model, particularly one that employs sequence processing techniques and cross-attention mechanisms, introduces a technical solution to the problem of effectively implementing audio edits using machine learning models. The model's capability to focus on and process specific parts of the audio signal based on the context provided by the vector-based representation enhances the accuracy of audio editing.

As yet another example, the system's ability to generate and modify audio signals based on user interactions with an interactive event roll visualization interface represents a technical contribution to the field of audio editing. The interactive interface allows users to interactively specify and visualize changes to the audio track, which are then numerically translated into edits processed by the audio editing model. This capability not only enhances the user's ability to make precise adjustments but also facilitates a more intuitive editing process. The ability to transform user interactions into a format that can be computationally processed to achieve the desired audio outcomes is a technical improvement that solves the technical problem of integrating user input directly into the audio editing workflow.

Various example implementations are described herein with respect to the accompanying Figures.

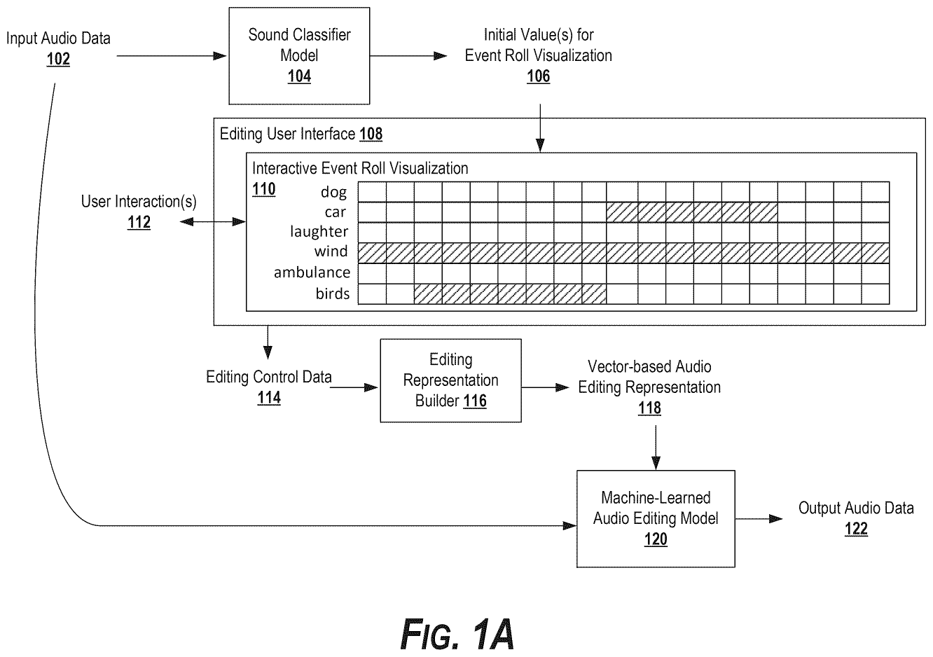

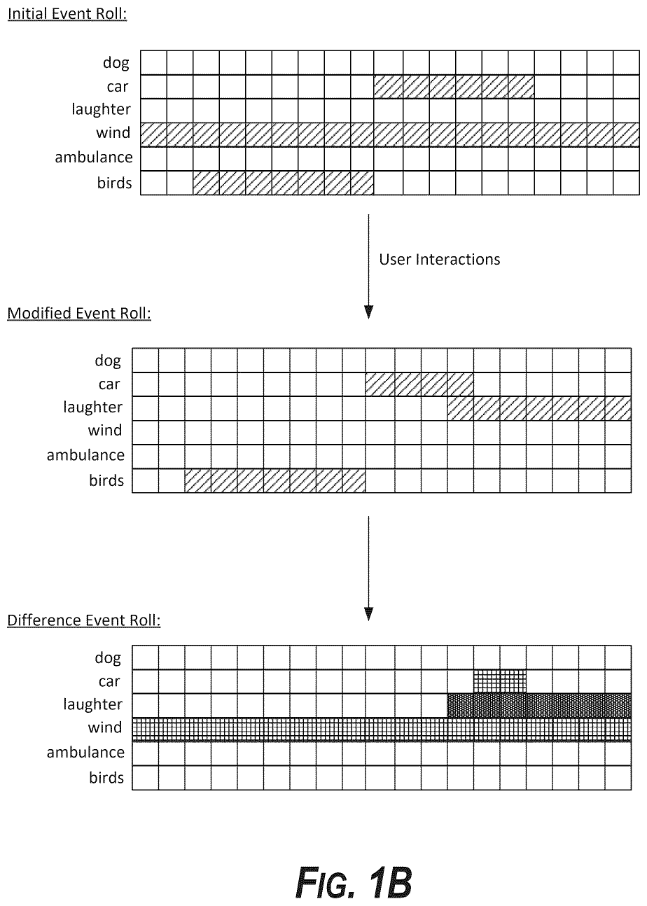

FIG. 1A illustrates a flow diagram of an audio editing system that can utilize a machine-learned model for editing audio data. The components of the system interoperate to facilitate the transformation of input audio data 102 into modified output audio data 122, which can be influenced by user interactions and machine learning processes.

Input audio data 102 can comprise raw audio files or streams that are input into the system for processing. These files or streams can exist in various formats, including WAV, MP3, or AAC. Alternatively, the input audio data 102 can be or include spectrograms, audio tokens, or other forms of representing audio information.

Initially, the input audio data 102 is processed by the sound classifier model 104, which can be trained to identify and classify distinct sound types within the audio data. For example, the sound classifier model 104 can distinguish between sounds such as speech, music, environmental noise, and other audio signatures.

The outputs of the sound classifier model 104 can be used to establish the initial values for an interactive event roll visualization 106. Specifically, the sound classifier model 104 can process the input audio data 102 to identify and classify distinct sound types, such as speech, music, and environmental noises. These classifications can then be used to generate a temporal rollout of the sound events detected in the audio data. To refine this data for visualization, techniques such as smoothing and thresholding can be applied. Smoothing can help in reducing noise and variability in the data, providing a cleaner and more continuous representation of sound events over time. Thresholding, on the other hand, can assist in distinguishing between significant and insignificant sound events by setting a minimum intensity or probability level that sound events must exceed to be included in the visualization. These processed outputs are then used to populate the initial values for the interactive event roll visualization 106.

In particular, the initial value(s) for event roll visualization 106 encompass the initial settings or parameters employed to display an interactive event roll visualization 110 within an editing user interface 108.

The editing user interface 108 enables user to interact with the audio data in a visual manner. This interface can include tools and controls for manipulating the audio data, for example, sliders, buttons, and editable timelines. For example, the editing user interface can include the interactive event roll visualization 110 that displays a range of values for various sound classes or types over time, enabling users to interactively manipulate audio properties directly.

The interactive event roll visualization 110 is a graphical representation that illustrates audio events over time and permits users to manipulate audio properties through the interface. This visualization can display various sound events as bars or lines on a timeline, where the length and position of each bar may indicate the duration and timing of the sound events. For example, users can insert new audio events, delete unwanted ones, and modify the properties of existing events directly through the interface.

The user can perform one or more user interactions 112 with the editing user interface 108 (e.g., with the interactive event roll visualization 110). User interaction(s) 112 can include actions taken by users to modify the audio data through the editing user interface 108. These actions may involve resizing, moving, or altering the properties of the visual representations within the interactive event roll visualization 110. For example, a user can extend the duration of a laughter segment in a podcast to enhance its effect or decrease the volume of background traffic noise in a video recording.

As one example, users can remove unwanted audio segments by eliminating corresponding bars in the visualization 110, which silences those parts in the final output. In some implementations, adding new bars can introduce new sounds or audio events at specified times. Temporal adjustments can be achieved by dragging bars left or right. As another example, users can adjust the height, color intensity, or other attribute(s) of the bars, which may indicate changes in volume and/or other audio effects applied to specific segments.

In some implementations, the editing user interface 108 can include the capability for users to enter free-form text that describes desired edits. For example, a user can input text specifying to “reduce background audio content in the first five minutes” or “enhance the clarity of speech throughout.” Furthermore, in some implementations, the user can interact with the interactive event roll visualization 110 to specify temporal ranges and/or semantic portions of the audio signal to which the edits described by the free-form text should be applied. For example, user interactions with the interactive event roll visualization 110 and/or other user interface elements can result in the creation of an activity roll that specifies the temporal location of a requested edit. The semantic content for the requested edit can be captured using an embedding of the free-form textual input. By interacting with the visualization, a user can highlight a specific time segment or select a semantic label, such as “dialogue” or “music”, to apply the textual edits with precision.

Editing control data 114 is generated based on user interaction(s) 112. This data encapsulates modifications made by the user and translates these into a format that may be processed by the system. For instance, the editing control data 114 can include information regarding which audio events have been extended, shortened, moved, or otherwise altered by the user. For example, this data can be generated based on user interactions with the editing user interface, which numerically encodes these modifications.

In some implementations, the editing control data 114 may be represented as a difference event roll. This difference event roll can numerically encode modifications made by users through an interactive event roll visualization in the editing user interface. For example, should a user alter the duration or volume of a sound event within the interactive event roll, these modifications can be recorded in the difference event roll. Thus, the difference event roll can encode the variations between the initial and modified states of the audio event rolls.

Editing representation builder 116 can process the editing control data 114 to construct a vector-based audio editing representation 118. This component can translate user modifications into a numerical format that describes the intended edits to the audio data. As one example, it can convert alterations made in the interactive event roll visualization 110 into a series of vectors that represent various audio editing commands, such as adding a dog bark sound at a particular time interval as a positive value in the vector, while a command to remove background audio content during a different interval can be represented as a negative value.

Vector-based audio editing representation 118 is a numerical description that, for example, can be structured either as a matrix or as a set of vectors. Each vector in this set can correspond to specific edits, which may include additions or deletions, and can encode details pertaining to temporal information and sound class, type, or semantics. This representation facilitates the application of edits to audio data. For example, the vector-based representation can include instructions to add echo to background footsteps or increase the clarity of vocals, providing a precise and efficient way to convey complex editing instructions to the machine-learned audio editing model.

In certain implementations, the editing representation builder 116 may be a learned component (e.g., a machine-learned model) and the vector-based audio editing representation 118 can be expressed as one or more embeddings within a learned, latent space. This configuration allows the system to leverage the ability of a machine-learned model to generate editing representations that are both contextually aware and highly adaptable to the specifics of the input audio signal. In implementations where the editing representation builder 116 is a learned component, it can be jointly trained with the primary model 120 or can be separately trained (e.g., pre-trained). In other implementations, the builder 116 can operate based on heuristic or algorithmic principles. The builder 116 can execute predefined rules or algorithms to generate the vector-based audio editing representation 118.

The machine-learned audio editing model 120 can process the input audio data 102 in conjunction with the vector-based audio editing representation 118 to produce output audio data 122. This model can be trained to identify various sound classes, types, or other semantic representations and may apply the appropriate edits in accordance with the instructions encoded in the vector-based representation. For example, the audio editing model can modify the input audio signal to amplify laughter sounds during a specific interval if the editing representation indicates an enhancement of laughter within that time frame.

The output audio data 122 represents the end result of the audio editing process, incorporating all user-specified modifications. This data can be output in various audio formats appropriate for diverse applications, such as WAV or MP3 files, or it may be streamed directly to audio playback devices. For example, the output data can be delivered as an audio file in formats such as WAV or MP3, or it could be streamed directly to audio playback devices. As another example, the output audio data 122 can be or include spectrograms, audio tokens, or other representations of audio information.

To provide an example, FIG. 1B illustrates an example of an initial event roll, a modified event roll, and a difference event roll in the context of an audio editing system. As illustrated in FIG. 1B, the initial event roll visually represents an initial display of various sound classes over time that are present within an input audio signal. Each row corresponds to a different sound class, including, as examples, dog, car, laughter, wind, ambulance, and birds. The shaded areas within each row indicate the presence and duration of the respective sound classes in the audio signal. For instance, the dog sound class is represented as having one occurrence throughout some, but not all of the audio signal, whereas the wind sound class is depicted as a continuous presence over a longer duration.

The user can interact with the interactive event roll to modify the values contained within the interactive event roll. User interactions can include actions executed by users to modify audio data via an editing user interface, which encompasses the initial event roll. These actions can include resizing, moving, or altering the properties of the visual representations within the initial event roll. In some implementations, a user can shorten the duration of a car sound, introduce laughter at specific intervals, and entirely eliminate the wind sound.

As illustrated in FIG. 1B, the modified event roll displays the state of the event roll subsequent to the user interactions. It represents the revised configuration and inclusion of sound classes following the modifications. In some implementations, the car sound class may exhibit a shortened duration, the laughter sound class may be present at different intervals, and the wind sound class may no longer appear, indicating that the user has removed the wind sound.

The difference event roll provides a representation of the specific alterations (e.g., the difference) between the initial event roll and the modified event roll. It serves to specifically represent the modifications executed by the user. Each row corresponds to various sound classes, and the internal values within these rows can indicate the type of modification applied. In some implementations, one type of value (e.g., a positive value) may correspond to the addition of a sound class, while a second type of value (e.g., a negative value) may correspond to a reduction or alteration in the sound class, while a third type of value (e.g., a zero value) may correspond to no change/edit. Other types of values/edits and possible as well. The difference event roll can be utilized to generate a vector-based audio editing representation that numerically describes the edits to be applied to the original audio signal.

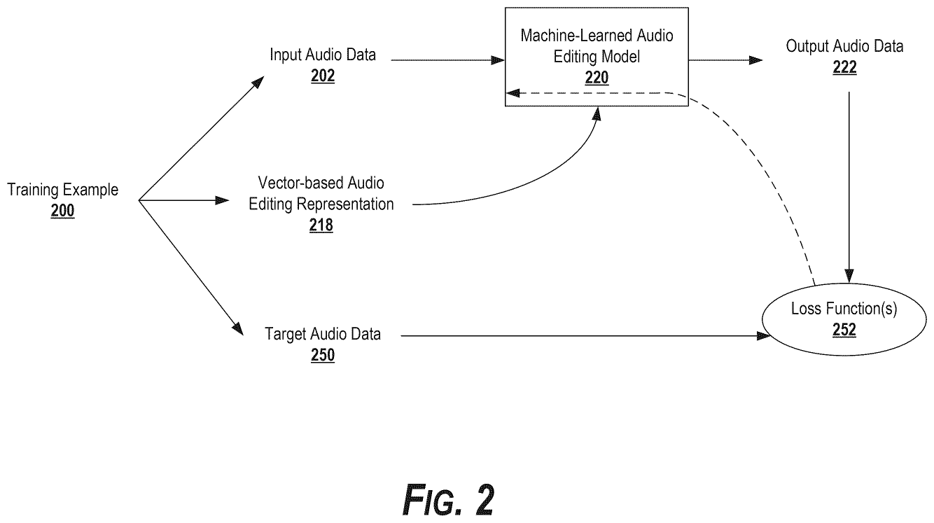

FIG. 2 provides a schematic diagram illustrating the training process of a machine-learned audio editing model. This diagram delineates the flow of data through various components of the system, which collectively facilitate the training and refinement of the audio editing model.

Training example 200 may serve as an input for the training process. It can include a set of predefined audio editing tasks that may be utilized to train the machine-learned audio editing model 220. In some implementations, each training example 200 can comprise input audio data 202, a vector-based audio editing representation 218, and target audio data 250, which collectively define or demonstrate a specific audio editing scenario.

Input audio data 202 comprises the initial audio signals or files that are subject to editing, which can include a variety of audio content such as speech, music, and environmental sounds. The input audio data 202 can be processed by the machine-learned audio editing model 220. This model can apply audio editing operations based on the vector-based audio editing representation 218. For example, the input data can describe an input audio signal in various forms such as a raw audio signal, an audio spectrogram, or a sequence of audio tokens, and the system can transform audio data into or between these forms.

Vector-based audio editing representation 218 is a numerical or vectorial representation of the editing operations that can be applied to the input audio data 202. This representation can include details such as the types of edits, the timing of edits, and the parameters of the audio effects to be applied. For instance, it may specify the addition of a reverb effect starting at a particular timestamp, or the removal of background audio content throughout the audio file.

Target audio data 250 serves as a reference for the training of the machine-learned audio editing model 220. It represents the desired target for the output audio data 222 after the application of the editing operations specified in the vector-based audio editing representation 218 to the input audio data 202.

The machine-learned audio editing model 220 can process the input audio data 202 in accordance with the instructions encoded in the vector-based audio editing representation 218 to generate the output audio data 222. This model can utilize various machine learning architectures, including neural networks or other model architectures, which are capable of performing complex audio processing tasks. For example, the machine-learned audio editing model utilized in the system can be or include a sequence processing model (e.g., a Transformer-based model), which is adept at handling data where the order of elements is significant, such as audio signals. As one example, the machine-learned audio editing model could be similar to or include a RQ-Transformer as described in Lee et al., Autoregressive Image Generation using Residual Quantization, arXiv:2203.01941 [cs. CV]. Additionally, other types of models, such as diffusion models, can also be employed depending on the specific requirements of the audio editing tasks.

Output audio data 222 represents the result of applying the editing instructions to the input audio data 202 by the machine-learned audio editing model 220. This output is subsequently compared by loss function(s) 252 to the target audio data 250 to evaluate the accuracy and effectiveness of the audio editing model.

Loss function(s) 252 are functions that quantify the difference (or other measures of comparison or evaluation) between the output audio data 222 and the target audio data 250. The results from the loss function(s) 252 can be utilized to adjust and refine the parameters of the machine-learned audio editing model 220, with the objective of minimizing the difference and thereby potentially improving the model's performance. In some implementations, examples of loss functions can include mean squared error, cross-entropy, and/or other relevant metrics that may measure the fidelity and quality of audio signals. For example, these loss functions can measure how closely the output audio matches the target audio in terms of sound quality and/or accuracy of the edits applied. Based on the results of this evaluation, the system can modify the parameters (e.g., via backpropagation of the loss function(s) 252) of the audio editing model 220 to improve future performance.

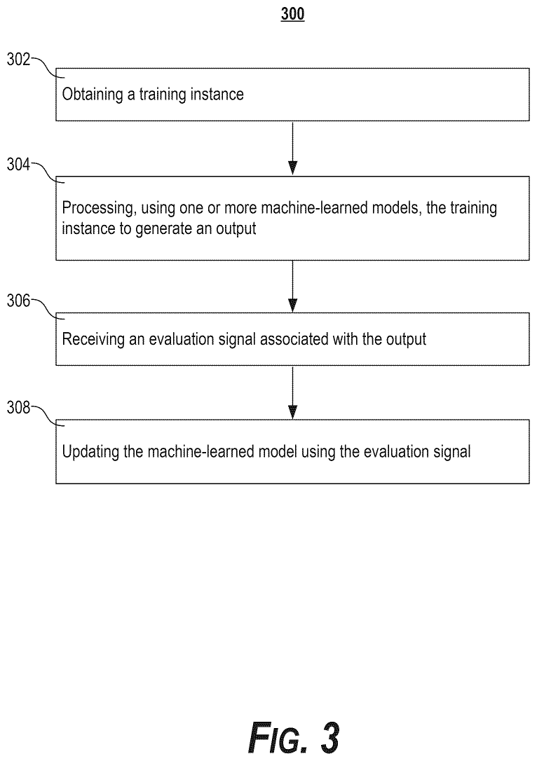

FIG. 3 depicts a flowchart of a method 300 for training one or more machine-learned models according to aspects of the present disclosure. One or more portion(s) of example method 300 can be implemented by a computing system that includes one or more computing devices such as, for example, computing systems described with reference to the other figures. Each respective portion of example method 300 can be performed by any (or any combination) of one or more computing devices. Moreover, one or more portion(s) of example method 300 can be implemented on the hardware components of the device(s) described herein, for example, to train one or more systems or models. FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 3 is described with reference to elements/terms described with respect to other systems and figures for exemplary illustrated purposes and is not meant to be limiting. One or more portions of example method 300 can be performed additionally, or alternatively, by other systems.

At 302, example method 300 can include obtaining a training instance. A set of training data can include a plurality of training instances divided between multiple datasets (e.g., a training dataset, a validation dataset, or testing dataset). A training instance can be labeled or unlabeled. Although referred to in example method 300 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 304, example method 300 can include processing, using one or more machine-learned models, the training instance to generate an output. The output can be directly obtained from the one or more machine-learned models or can be a downstream result of a chain of processing operations that includes an output of the one or more machine-learned models.

At 306, example method 300 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 308, example method 300 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 300 can include implementing a number of generalization techniques (e.g., weight decays, dropouts, etc.) to improve the generalization capability of the models being trained.

In some implementations, example method 300 can be implemented for training a machine-learned model from an initialized state to a fully trained state (e.g., when the model exhibits a desired performance profile, such as based on accuracy, precision, recall, etc.).

In some implementations, example method 300 can be implemented for particular stages of a training procedure. For instance, in some implementations, example method 300 can be implemented for pre-training a machine-learned model. Pre-training can include, for instance, large-scale training over potentially noisy data to achieve a broad base of performance levels across a variety of tasks/data types.

In some implementations, example method 300 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 300 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 300 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

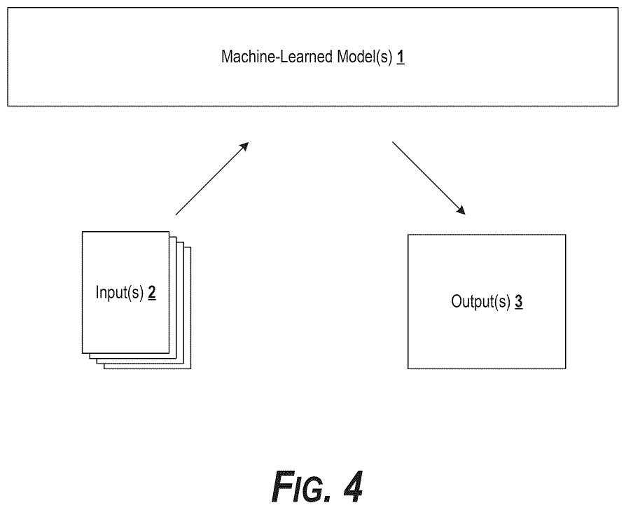

FIG. 4 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any of the machine-learned components described herein, etc. Although various features, variations, and implementations described below are described with respect to machine-learned model(s) 1, it is to be understood that such features, variations, and implementations are to be understood as described with respect to any of the machine-learned components described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

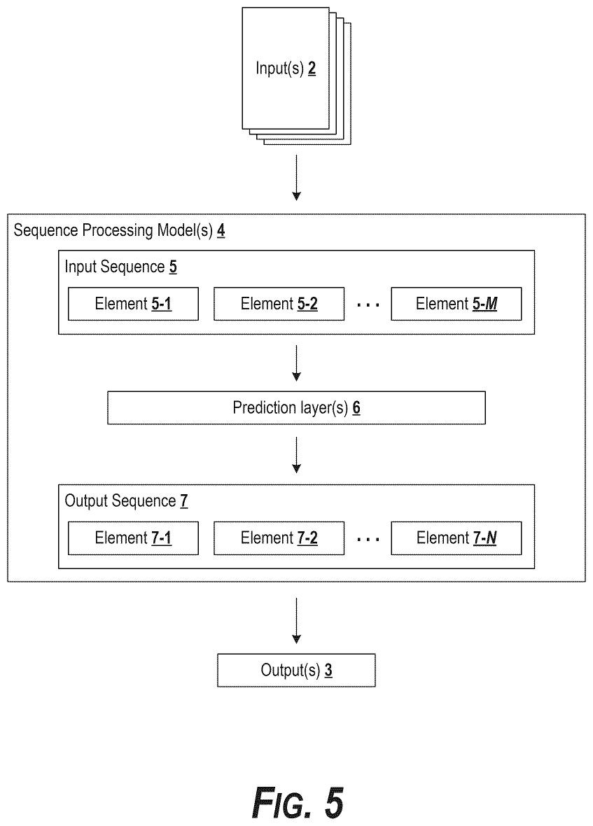

FIG. 5 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 1×16Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . 5-M depicted in FIG. 5 can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

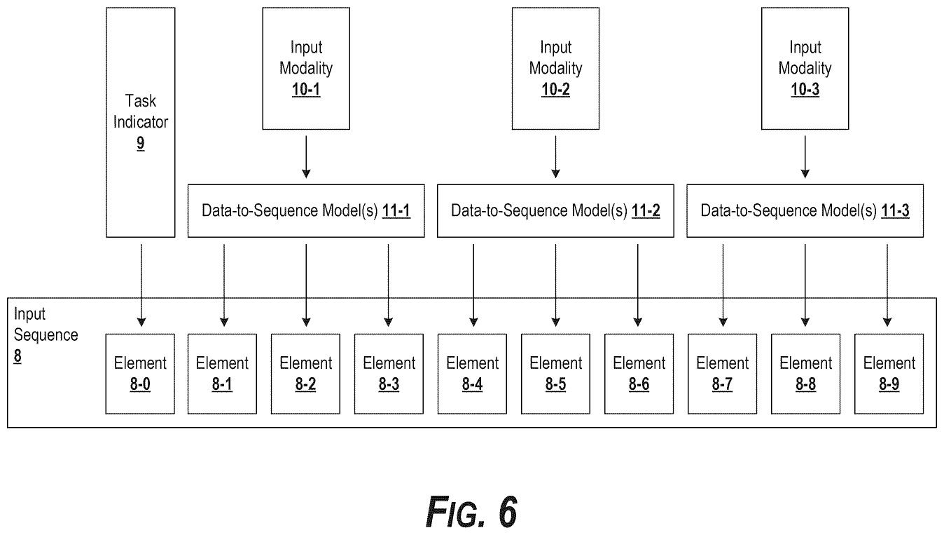

FIG. 6 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

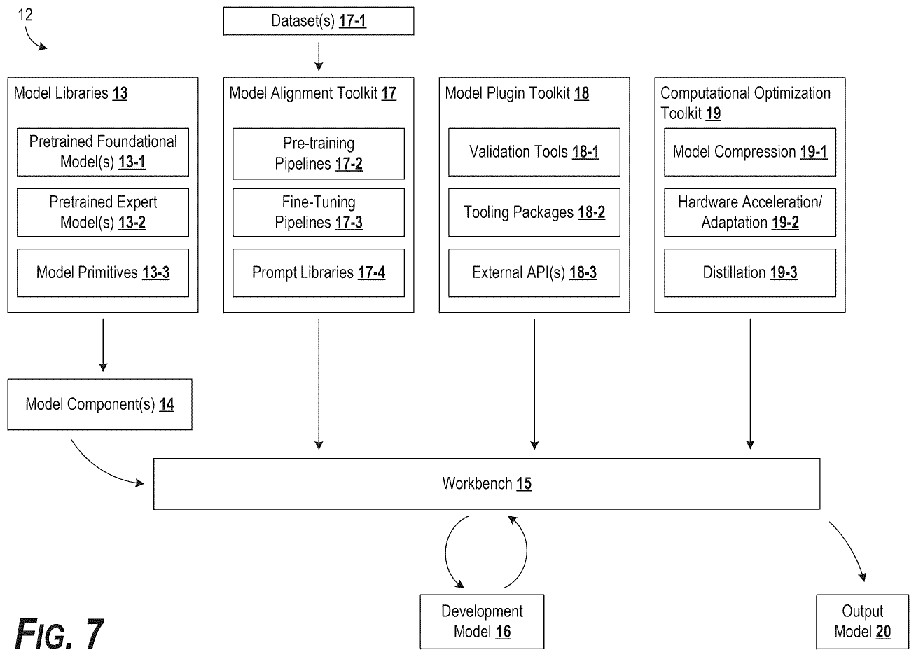

FIG. 7 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 300 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

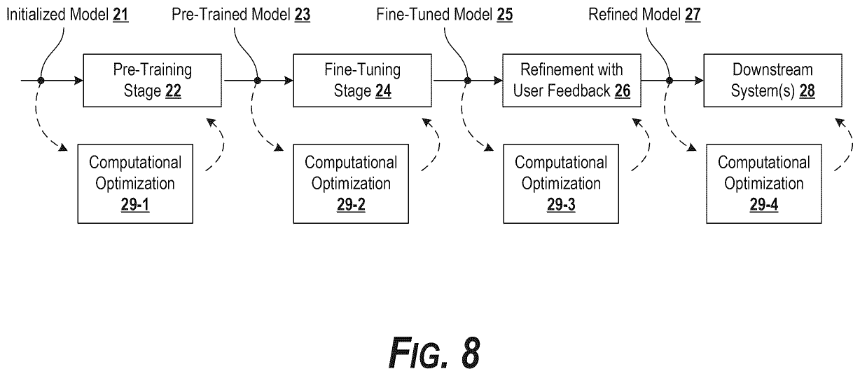

FIG. 8 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . 29-4 can all be the same, all be different, or include at least some different optimization techniques.

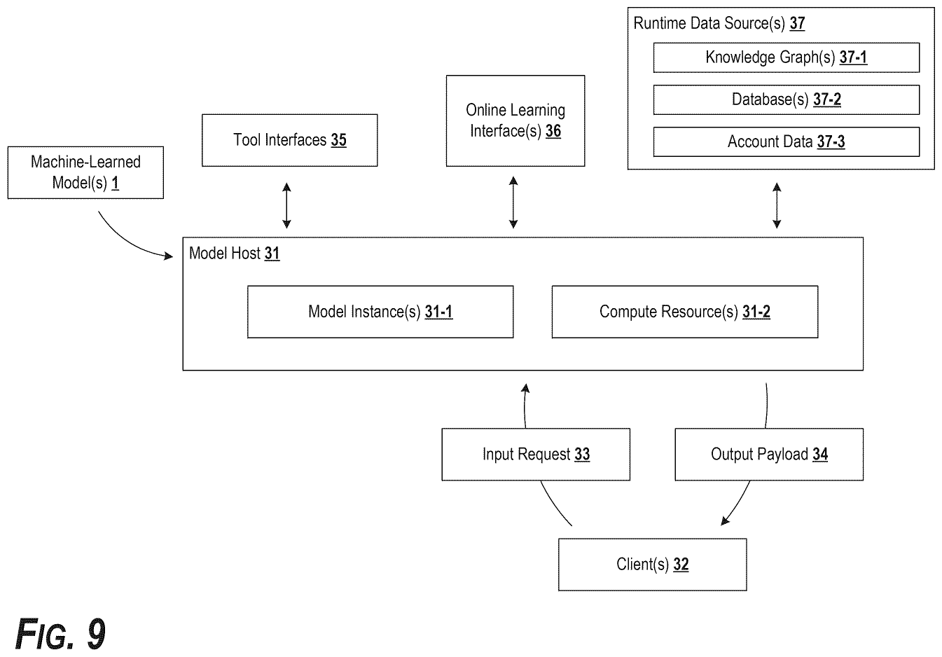

FIG. 9 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

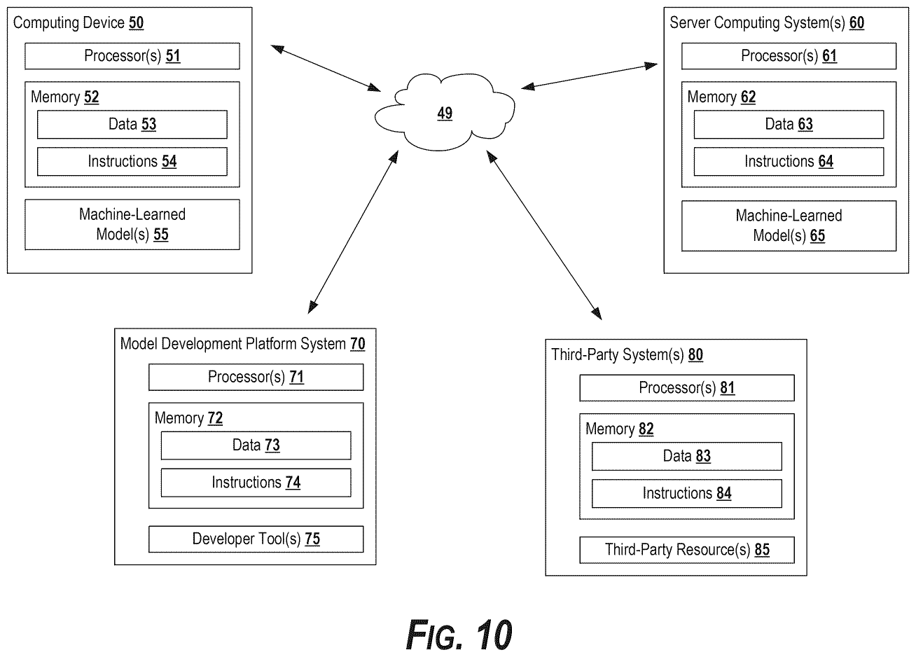

FIG. 10 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 10 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 10 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

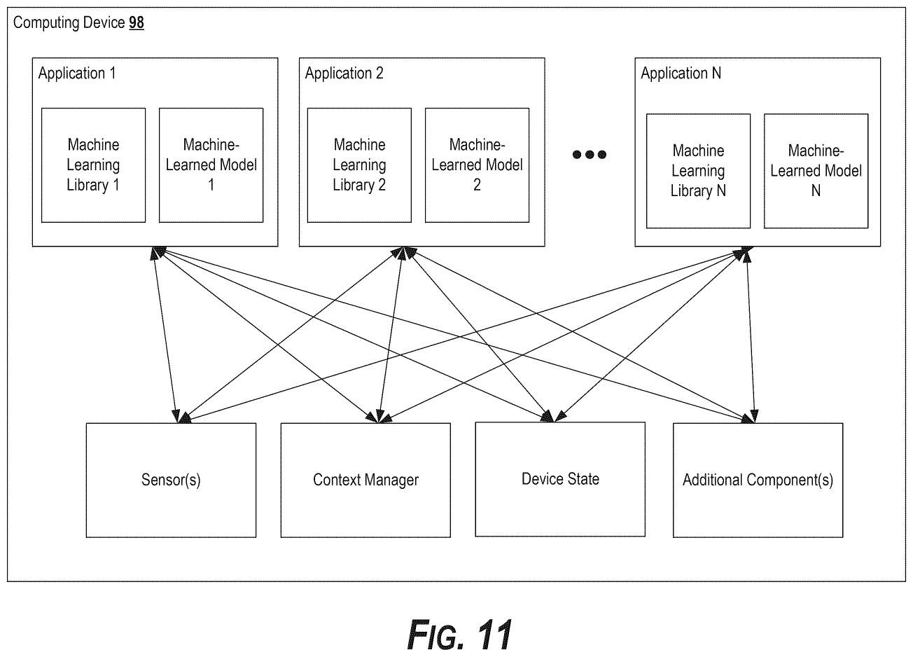

FIG. 11 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 11, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

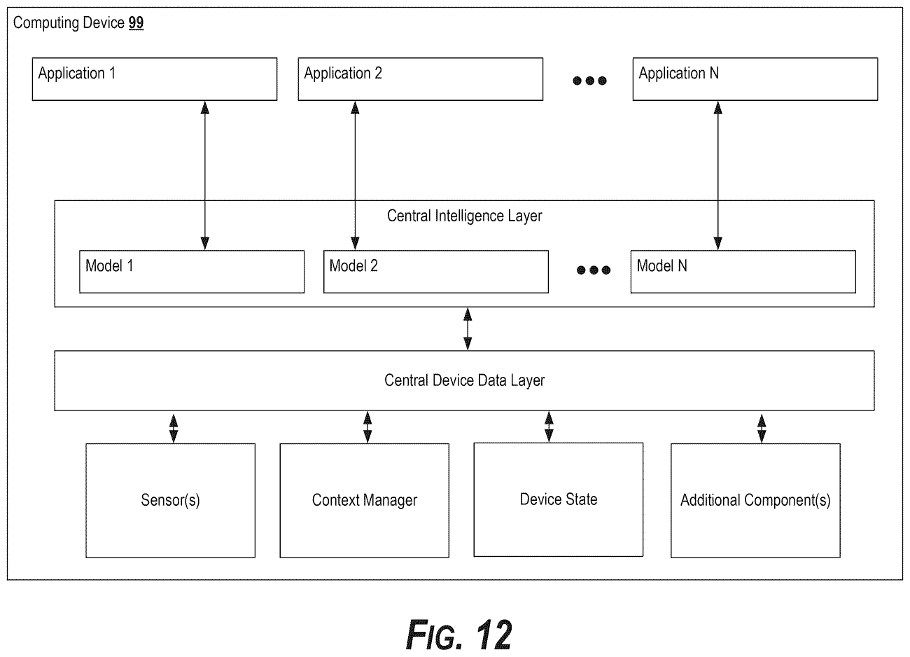

FIG. 12 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 12, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 12, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for audio editing, the method comprising:
obtaining, by a computing system comprising one or more computing devices, input data descriptive of an input audio signal;
generating, by the computing system, a vector-based audio editing representation that numerically describes one or more edits to the input audio signal;
processing, by the computing system, the input data and the vector-based audio editing representation with a machine-learned audio editing model to generate, as an output of the machine-learned audio editing model, output data descriptive of an output audio signal, wherein the output audio signal corresponds to the one or more edits to the input audio signal; and
providing, by the computing system, the output data as an output.

2. The computer-implemented method of claim 1, wherein the input data comprises an input audio spectrogram or wherein the output data comprises an output audio spectrogram.

3. The computer-implemented method of claim 1, wherein the input data comprises an input audio waveform or wherein the output data comprises an output audio waveform.

4. The computer-implemented method of claim 1, wherein the input data comprises an input sequence of audio tokens or wherein the output data comprises an output sequence of audio tokens.

5. The computer-implemented method of claim 1, wherein generating, by the computing system, the vector-based audio editing representation comprises:
receiving, by the computing system, editing control data generated based on one or more user interactions with an editing user interface comprising an interactive event roll visualization, wherein the interactive event roll visualization depicts a plurality of values respectively for a plurality of different sound classes over time; and
generating, by the computing system, the vector-based audio editing representation based at least in part on the editing control data.

6. The computer-implemented method of claim 5, further comprising, prior to receiving the editing control data:
analyzing, by the computing system, the input audio signal with a sound classifier model to generate an initial set of values for the interactive event roll visualization; and
providing, by the computing system, the interactive event roll visualization for display in the editing user interface with the initial set of values.

7. The computer-implemented method of claim 5, wherein the one or more user interactions with the editing user interface comprise user interactions that modify one or more of the plurality of values of the interactive event roll visualization.

8. The computer-implemented method of claim 7, wherein generating the vector-based audio editing representation based at least in part on the editing control data comprises:
determining, by the computing system, a difference event roll that indicates a difference between an initial version of the interactive event roll visualization and a final version of the interactive event roll visualization following the user interactions that modify the one or more of the plurality of values of the interactive event roll visualization; and
generating, by the computing system, the vector-based audio editing representation based at least in part on the difference event roll.

9. The computer-implemented method of claim 5, wherein the one or more user interactions comprise:
one or more free-form textual inputs that textually describe the one or more edits to the input audio signal; and
one or more activity rolls that respectively indicate temporal boundaries of the one or more edits to the input audio signal.

10. The computer-implemented method of claim 9, wherein generating, by the computing system, the vector-based audio editing representation based at least in part on the editing control data comprises:
generating, by the computing system, a textual embedding for each free-form textual input; and
generating, by the computing system, the vector-based audio editing representation that numerically indicates the textual embedding and the temporal boundaries for each free-form textual input.

11. The computer-implemented method of claim 1, wherein the one or more edits to the input audio signal comprise an audio generation edit, an audio removal edit, an audio transformation edit, an audio time-shifting edit, and an audio enhancement edit.

12. The computer-implemented method of claim 1, wherein the machine-learned audio editing model comprises a sequence processing model.

13. The computer-implemented method of claim 1, wherein processing, by the computing system, the input data and the vector-based audio editing representation with the machine-learned audio editing model comprises processing the input data with the machine-learned audio editing model while performing cross-attention on the vector-based audio editing representation.

14. A computing system configured to train a machine-learned audio editing model, the computing system comprising:
one or more processors; and
one or more non-transitory computer-readable media that collectively store instructions for performing operations, the operations comprising:
obtaining, by a computing system comprising one or more computing devices, input data descriptive of an input audio signal, a vector-based audio editing representation that numerically describes one or more edits to the input audio signal, and target data descriptive of a target audio signal, wherein the target audio signal demonstrates the one or more edits to the input audio signal;
processing, by the computing system, the input data and the vector-based audio editing representation with a machine-learned audio editing model to generate, as an output of the machine-learned audio editing model, output data descriptive of an output audio signal;
evaluating, by the computing system, one or more loss functions that compare the output data to the target data; and
modifying, by the computing system, one or more values of one or more parameters of the machine-learned audio editing model based on the one or more loss functions.

15. The computing system of claim 14, wherein the input audio signal consists of background audio content; and wherein obtaining, by the computing system, the input data and the target data comprises inserting foreground audio into the input audio signal to generate the target audio signal.

16. The computing system of claim 14, wherein the target audio signal consists of background audio content; and wherein obtaining, by the computing system, the input data and the target data comprises inserting foreground audio into the target audio signal to generate the input audio signal.

17. The computing system of claim 14, wherein obtaining, by the computing system, the input data and the target data comprises inserting first foreground audio into a background signal to generate the input audio signal and inserting second, different foreground audio into the background signal to generate the target audio signal.

18. The computing system of claim 14, wherein obtaining, by the computing system, the input data and the target data comprises inserting foreground audio into a background signal at a first time to generate the input audio signal and inserting the foreground audio into the background signal at a second, different time to generate the target audio signal.

19. The computing system of claim 14, wherein obtaining, by the computing system, the input data and the target data comprises increasing a volume of at least a portion of the input audio signal to generate the target audio signal.

20. One or more non-transitory computer-readable media that collectively store:
a machine-learned audio editing model configured to:
process input data descriptive of an input audio signal and a vector-based audio editing representation that numerically describes one or more edits to the input audio signal; and
as a result of said processing, generate, as an output of the machine-learned audio editing model, output data descriptive of an output audio signal,
wherein the output audio signal corresponds to the one or more edits to the input audio signal.
